(19) United States
(12) Patent Application Publication
(10) Pub. No.: US 2007/0208135 A1
(43) Pub. Date: Sep. 6, 2007

(54) Cross-Linked Composition Comprising a Triblock Sequenced Copolymer, Method for the Production Thereof, and Uses of the Same

(76) Inventors: Laurent Gervat, Brassempouy (FR); Nicolas Garois, Amilly (FR); Philippe Sonntag, Hericy (FR); Adrian Verschave, Amilly (FR); Logan Bouchereau, Montargis (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/590,322

(22) PCT Filed: Feb. 23, 2005
(86) PCT No.: PCT/FR05/00420

§ 371 Date: Aug. 23, 2006

(30) Foreign Application Priority Data
Feb. 24, 2004 (FR) 0401826
Aug. 6, 2004 (FR) 0408713

(51) Int. Cl. C08L 53/00

(52) U.S. Cl. 525/88

(57) ABSTRACT

The invention relates to a cross-linked composition comprising at least one elastomer and at least one triblock block sequenced copolymer. The Invention also relates to a method for obtaining one such composition based on a system and a suitably selected crosslinking temperature. According to a preferred embodiment of the invention, the cross-linked composition can be transformed as a thermoplastic material. The inventive composition can be used in various applications, especially for producing conduits for the transfer of fluids, seals and insulation linings.

The present invention relates to a crosslinked composition, to its process of manufacture and to its uses. It discloses in particular a crosslinked composition comprising an elastomer and a triblock block copolymer, its process of preparation based on high-temperature crosslinking, and its uses.

The crosslinked composition of the invention has applications in the manufacture of certain articles, such as insulation seals and moldings, and also conduits for the transfer of fluids, such as those used in the automobile industry, for example in brake or cooling systems. Other applications, such as the manufacture of belts (such as transmission belts), of tires, of electric cable jackets or of shoe soles, can involve the compositions of the invention.

A specific case of the invention consists of such crosslinked compositions which can be converted like thermoplastics. This is because, for certain applications (insulation seals and moldings or fluid transfer conduit), it is desirable to have available materials which, while exhibiting properties similar to those of elastomers and in particular an ability to withstand significant deformations without failure and an ability to return to their starting geometry after strains of the elongation or compression type, even repeated strains of the elongation or compression type, as well as good resistance to heat, chemicals and weathering, can be processed by techniques and equipment which use processors of thermoplastics, mainly to make possible the recycling of these articles and that of the waste produced during the manufacture thereof, which recycling does not allow the use of elastomers.

Provision has consequently been made, in U.S. Pat. No. 4,130,535, for “thermoplastic elastomers” based on polyolefins which exhibit a structure composed of a noncrosslinked matrix of polypropylene and crosslinked nodules of ethylene/propylene/diene (EPDM) terpolymer, so as to exhibit, at the operating temperature, which is lower than the melting point of the polypropylene, a behavior analogous to that of elastomers after vulcanization, while the heating thereof above this melting point makes it possible to employ them as thermoplastics.

While these materials indeed exhibit a certain number of properties equivalent to those of elastomers, they exhibit, however, a high elongation set (greater than 50%) at temperatures of greater than 100° C., which makes their use rather unsuitable for the manufacture of articles intended to be used in regions where temperatures of more than 100° C. prevail, as may be the case with insulation and/or leaktightness seals and moldings or the conduits, hoses, pipes and the like provided for ensuring the transfer of fluids in the engine compartment of a motor vehicle.

In order to solve this problem, EP 0 840 763 B1 provides a solution based on the use of a crosslinked elastomer with thermoplastic conversion obtained by the crosslinking of a blend, subsequently denoted by “Vegaprene®”, comprising an elastomer based on poly(octene/ethylene) obtained by metallocene catalysis and polyolefin grafted with maleic anhydride. Although this solution is satisfactory, it nevertheless remains restricted to certain applications.

This is because the properties of the blends are generally different from those predicted by a simple linear interpolation of those of the constituents taken separately (elastomers and plastics). Synergistic effects can sometimes be present but there exists other cases where the properties are slightly inferior. This may be related to the morphology of the various phases, to the distribution of the fillers and plasticizers, to the nature of the interfaces or to the distribution of the vulcanization bridges in the various phases. To overcome these phenomena, recourse is generally had to compatibilizing agents or to coagents, which are expensive and difficult to incorporate into the blends.

In the case in particular of the properties of resistance to repeated stresses, the fatigue behavior of the compounds is essential. This can be obtained using coagents, such as zinc methacrylate. However, due to the polarity of this compound, the latter is difficult to disperse in the blends. Furthermore, its high reactivity with the metal at high temperature results in blends which adhere to the mixing tools. It is consequently not used to any great extent. Another advantageous property may be the resistance to high elongation. This characteristic is difficult to obtain with the blends disclosed in EP 0 840 763 B1.

Finally, in some cases, the improvement in the Compression Set, generally denoted by CS, obtained by the application of the process disclosed in EP 0 840 763 B1 may prove to be inadequate.

To solve the problems described above and many others, the Applicant Company has found a solution based on a crosslinked composition comprising at least one elastomer and at least one triblock block copolymer and optionally a thermoplastic polymer.

The solution found by the Applicant Company makes it possible to solve the abovementioned problems without altering in a harmful way the other mechanical characteristics of the blends (dynamic properties, dissipation, hardness, rebound, and the like). The blend is easy to disperse according to the method described in the present invention. Furthermore, it exhibits the advantage of not adhering to the equipment.

The first subject matter of the invention is thus a crosslinked composition comprising, as parts by weight:
20 to 100 parts of at least one elastomer (I),
2 to 50 parts of at least one triblock block copolymer (II), and
0 to 100 parts of at least one thermoplastic polymer (III).

Within the meaning of the present invention, the elastomer (I) can be chosen from the group consisting of natural rubbers (NRs), synthetic rubbers (BRs), elastomers with polymerization by metallocene catalysis, poly(ethylene/propylene)s (EPRs), poly(ethylene/propylene/diene)s (EPDMs), long-chain polyacrylates, such as poly(butyl acrylate) or poly(2-ethylhexyl acrylate), fluoroelastomers (FPMs), such as copolymers based on tetrafluoroethylene, and silicone elastomers.

The term “synthetic rubber (BR)” is understood to mean poly(conjugated diene)s, such as polybutadiene, polyisoprene and their block or random copolymers.

Within the meaning of the present invention, the term “elastomer with polymerization by a metallocene catalyst” is understood to mean any elastomer composed of a homopolymer, a copolymer or a terpolymer, the polymerization of which has been carried out using a metallocene catalyst, such as poly(octene/ethylene)s, also known as polyoctenes, which are available from Du Pont Dow Elastomers (DDE) under the trade name Engage.

According to the invention, the triblock block copolymer (II) corresponds to the following general formula:
Y—B—Y′
in which B is a block with an elastomeric nature, and Y and Y′ are thermodynamically incompatible with the block B. They can be identical or different in chemical composition and at least one of them is composed predominantly of methacrylic monomers.

The block B is an elastomer which can belong to the family of the polyolefins, polyacrylates, polyurethanes, polyethers, such as polyoxyethylene or polyoxypropylene, and nitrile elastomers. In particular, the monomer used to synthesize the elastomeric block B can be an alkene, such as isobutylene, a long-chain acrylate or methacrylate, such as butyl acrylate or 2-ethylhexyl acrylate, or a diene chosen from butadiene, isoprene, 2,3-dimethyl-1,3-butadiene, 1,3-pentadiene or 2-phenyl-1,3-butadiene.

B is advantageously chosen from poly(diene)s, in particular poly(butadiene), poly(isoprene) and their random copolymers, or from poly(diene)s partially or completely hydrogenated according to the usual techniques. Among polybutadienes, use is advantageously made of those having the lowest glass transition temperature Tg, for example poly(1,4-butadiene), with a Tg (approximately −90° C.) lower than that of poly(1,2-butadiene) (approximately 0° C.).

The blocks B are preferably composed predominantly of poly(1,4-butadiene).

Advantageously, the Tg of B is less than 0° C. and preferably less than −40° C.

Y and Y′ can be obtained by the polymerization of at least one monomer chosen from the group consisting of styrene and its derivatives, and short-chain methacrylates, such as methyl methacrylate.

Preferably, Y′, then denoted by M, is composed of methyl methacrylate monomers or comprises at least 50% by weight of methyl methacrylate, preferably at least 70% by weight of methyl methacrylate. The other monomers constituting this block may or may not be acrylic monomers and may or may not be reactive. Mention may be made, as nonlimiting examples of reactive functional groups, of: oxirane functional groups, amine functional groups, anhydride functional groups or carboxylic acid functional groups. The reactive monomer can be a hydrolyzable monomer resulting in acids. Mention may be made, among the other monomers which can constitute the Y′ block, as nonlimiting examples, of glycidyl methacrylate, tert-butyl methacrylate or glutarimide.

According to an advantageous form, the Y′ block comprises imide functional groups preferably in a proportion of between 30 and 60 mol% of Y′. These imide functional groups can be obtained by imidization. Advantageously, the imidization of 2 adjacent MMA functional groups is carried out. The imidization is described, for example, in patents EP 275 918, EP 315 149, EP 315 150, EP 315 151 and EP 331 052, the content of which is incorporated in the present application. The composition of the invention can be prepared by using a triblock copolymer (II) having a Y′ block which has already been imidized or the imidization can be carried out during the blending of the components (I), (II) and optionally (III) of the invention.

Advantageously, M is composed of poly(methyl methacrylate) (PMMA) syndiotactic to at least 60%.

When Y is different in chemical composition from Y′, as in the case of the examples below, it can be obtained by the polymerization of vinylaromatic compounds, such as, for example, styrene, α-methylstyrene, vinyltoluene or vinylpyridines. Y is then denoted by S. The Tg of Y (or S) is advantageously greater than 23° C. and preferably greater than 50° C.

The triblock copolymer Y—B—Y′ according to the invention is subsequently denoted by S—B-M.

According to the invention, the S—B-M has a number-average molar mass which can be between 10 000 g/mol and 500 000 g/mol, preferably between 20 000 and 200 000 g/mol. The S—B-M triblocks advantageously have the following composition, expressed as fraction by weight, the total being 100%:
M: between 10 and 80% and preferably between 15 and 70%,
B: between 2 and 80% and preferably between 5 and 70%,
S: between 10 and 88% and preferably between 5 and 85%.

According to the invention, the block copolymer (II) can comprise at least one S—B diblock in which the S and B blocks have the same properties as the S and B blocks of the S—B-M triblocks. They are composed of the same monomers and optionally comonomers as the S blocks and the B blocks of the S—B-M triblocks.

The S—B diblock has a number-average molar mass which can be between 5000 g/mol and 500 000 g/mol, preferably between 10 000 and 200 000 g/mol. The S—B diblock is advantageously composed of a fraction by weight of B of between 5 and 95% and preferably between 15 and 85%.

The blend of S—B diblock and of S—B-M triblocks is denoted below by SBM. This blend advantageously comprises between 5 and 80% of S—B diblock for respectively from 95 to 20% of S—B-M triblocks.

One advantage of these SBM block compositions is that it is not necessary to purify the S—B-M on conclusion of its synthesis.

The thermoplastic polymer (III) is chosen, for example, from polyolefins, which may or may not be modified, polyamides, polyesters, thermoplastic polyurethanes, fluoropolymers and chloropolymers, such as poly(vinyl chloride) (PVC).

The thermoplastic polymer (III) is advantageously a functionalized polyolefin. The thermoplastic polymer (III) is preferably a grafted polyolefin chosen from the group consisting of polyethylenes, polypropylenes and poly(ethylene/propylene)s grafted with acrylic acid, maleic anhydride or glycidyl methacrylate.

Advantageously, the crosslinked composition in accordance with the invention can also include a polyacrylic elastomer, such as a terpolymer of ethylene, of acrylate and of acrylic acid or a terpolymer of styrene, of acrylonitrile and of acrylate, which acts as UV stabilizer and as film-forming agent and which makes it possible to improve the surface appearance of the composition when the latter is processed by extrusion. When such a polyacrylic elastomer is used, it is preferably used in a proportion of 2 to 20 parts by weight per 100 parts by weight of the elastomer/triblock block copolymer blend.

Advantageously again, the composition of the invention can additionally comprise a plasticizer, the presence of which makes it possible to increase its flowability and, consequently, to facilitate the processing thereof, and also to adjust the hardness of the products resulting from this processing according to a desired hardness value. Preferably, this plasticizer is a paraffinic plasticizer of the type of those sold by Total under the trade name Plaxene or by Exxon under the trade name Flexon and is used in a proportion of 5 to 120 parts by weight per 100 parts by weight of the elastomer/triblock copolymer and optionally grafted polyolefin blend.

However, other plasticizers, such as a polyalkylbenzene, may also be suitable.

The composition can also include fillers of the light-colored fillers type: silicas, carbonates, clays, chalk, kaolin, and the like, or carbon blacks type. The use of the latter has proved to be particularly advantageous as they make it possible not only to adjust certain mechanical properties of the composition in accordance with the invention, such as the tensile strength or the tensile moduli, but also to confer thereon excellent resistance to the action of ultraviolet radiation. When such fillers are present in the composition, they are advantageously present at a level of 5 to 100 parts by weight per 100 parts by weight of the elastomer/triblock copolymer and optionally grafted polyolefin blend.

The crosslinked composition can additionally comprise other adjuvants conventionally employed in the polymers industry, such as, for example, antistatic additives, lubricants, antioxidants, coupling agents, colorants, processing aids or adhesion promoters, depending on the properties which it is desired to give it, provided, of course, that these adjuvants are compatible with one another.

The composition in accordance with the invention is said to be “crosslinked” because its preparation involves crosslinking the elastomer present in its composition.

For this reason, the composition according to the invention comprises, before crosslinking, at least one crosslinking system comprising one or more crosslinking agents suitably chosen according to the nature of the polymers present in its composition and one or more crosslinking promoters, the role of which is to activate the kinetics of the reaction and to increase the crosslinking density.

According to a preferred arrangement of the invention, this crosslinking system comprises, as crosslinking agent(s), one or more organic peroxides chosen from the group consisting of dicumyl peroxide, 1,3-bis(t-butyl-isopropyl)benzene peroxide, 2,5-dimethyl-2,5-bis(t-butyl)hexane peroxide and 1,1-bis(t-butyl)-3,3,5-tri-methylcyclohexane and, as crosslinking promoter(s), one or more compounds chosen from the group consisting of zinc oxide, stearic acid, N,N′-(m-phenylehe)-dimaleimide, triallyl cyanurate, triisoallyl cyanurate, methacrylates (such as tetrahydrofurfuryl methacrylate or 2-phenoxyethyl methacrylate), dimethacrylates (such as ethylene glycol dimethacrylate, tetraethylene glycol dimethacrylate, 1,4-butanediol dimethacrylate or zinc dimethacrylate), trimethacrylates (such as trimethylolpropane trimethacrylate) and diacrylates (such as zinc diacrylate).

According to another preferred arrangement of the invention, the crosslinking system is a system based on sulfur which comprises, in addition to zinc oxide and/or stearic acid as crosslinking promoter(s), one or more sulfur-donating accelerators, such as 4,4′-dithiomorpholine, tetramethylthiuram disulfide, dipentamethylenethiuram tetrasulfide or zinc dibutyldithiocarbamate, and optionally an antireversion agent, such as 1,3-bis(citraconimidomethyl)benzene.

According to a particularly preferred arrangement of the invention, the crosslinking system comprises, as crosslinking agent, a phenolic resin chosen from reactive alkylated methylphenol/formaldehyde and bromomethylphenol/formaldehyde resins and, as crosslinking promoter, a chloropolymer, such as a chlorinated or chlorosulfonated polyethylene or a polychloroprene, optionally in combination with zinc oxide and/or stearic acid. This is because the latter crosslinking system makes it possible to obtain elastomers which, in addition to exhibiting extremely satisfactory mechanical, elongation set and compression set properties, are characterized by a beautiful surface appearance.

In all cases, the crosslinking agent or agents are preferably present in the formulation at a level of 1 to 10 parts by weight per 100 parts by weight of the elastomer/triblock copolymer and optionally grafted polyolefin blend, while the crosslinking promoter or promoters are preferably present at a level of 0.5 to 12 parts by weight per 100 parts by weight of the blend.

When the vulcanization system is a sulfur-based system, the sulfur-donating accelerator or accelerators are, for their part, preferably present in the formulation at a level of 1 to 7 parts by weight per 100 parts by weight of the elastomer/triblock copolymer and optionally grafted polyolefin blend.

In accordance with the invention, the crosslinking of the composition can be carried out using two crosslinking systems. By way of examples, use may be made jointly of a crosslinking system based on sulfur and a crosslinking system based on organic peroxides or a crosslinking system based on a phenolic resin and a crosslinking system based on organic peroxides.

Depending on the nature of (I) and (III), the compositions of the invention can be converted by the techniques and equipment used for the processing of thermoplastics: thermoforming, injection molding, extrusion, forming, and the like. In this specific case, the compositions of the invention are described as “with thermoplastic processing”. Mention may be made, as examples of such compositions, of those in which the elastomer (I) is composed of a homopolymer, a copolymer or a terpolymer, the polymerization of which has been carried out using a metallocene catalyst, and the polymer (III) is present. Advantageously, (III) is a functionalized polyolefin, preferably a grafted polyolefin. It can be chosen from the grafted polyolefins as mentioned above. Mention may be made, by way of examples, of the blends of (I) and (III) known under the name of “Vegaprene®”.

The crosslinked compositions with thermoplastic conversion in accordance with the invention, while exhibiting mechanical properties in terms of hardness, of tensile strength and of elongation at break equivalent to those of the thermoplastic elastomers of the prior art mentioned above, have better properties of compression set and elongation set than the latter. This advantage is observed not only in the short term but also in the long term, where the compositions in accordance with the invention display a reduced tendency toward creep.

Another subject matter of the present invention is a process for the manufacture of a crosslinked composition as defined above, characterized in that it comprises the blending of an elastomer and of a triblock block copolymer, optionally in the presence of a grafted polyolefin, of a plasticizer, of fillers and/or of adjuvants, and the crosslinking of this blend by a suitably chosen crosslinking system at an appropriate temperature.

According to a preferred embodiment of the process in accordance with the invention, the temperature at which the crosslinking is carried out is between 150 and 320° C.

According to a particularly preferred embodiment of the process in accordance with the invention, the process comprises:

a) the blending of the elastomer, of the triblock block copolymer and of the crosslinking system in the presence, optionally, of the thermoplastic polymer, of the polyacrylic elastomer, of the plasticizer, of the fillers and/or of the adjuvants;

b) the heating of this blend to a temperature of between 150 and 320° C., and

c) its maintenance at this temperature for a time of between 1 and 15 minutes.

This process can be carried out in an internal mixer or, in an alternative form, in a twin-screw extruder or a co-kneader of the Buss type. The resulting mass is, according to the circumstances, calendered or extruded, then cooled and subjected to granulation. The granules thus obtained are ready to be converted—by heating these granules to give sheets, panels, profiles, pipes or other desired products.

Another subject matter of the present invention is the use of a crosslinked composition as defined above in the manufacture of insulation and/or leaktightness seals and moldings as employed for thermal or sound insulation and/or leaktightness toward water and toward moisture, in particular in the construction industry and in the automobile industry (door casings, for example).

An additional subject matter of the present invention is the use of such a composition in the manufacture of conduits, pipes, hoses, manifolds, nozzles or the like for the transfer of fluids. Mention may be made, by way of examples, of the conduits, hoses and other components provided for conveying fluids which are used by the automobile industry in brake, cooling, power assisted steering or air conditioning systems.

Mention may also be made of the use of the crosslinked composition of the invention in the manufacture of belts, tires, electric cable jackets and shoe soles.

The present invention will be better understood with the help of the remainder of the description which follows and which refers to implementational examples of the crosslinked composition in accordance with the invention.

Mention may be made, among the preferred compositions of the invention, by way of nonlimiting examples, of the three following compositions:

1. NR/BR compositions for dynamic applications: stops, engine support,

2. EPDM compositions, Vegaprene 3, for static application: seal,

3. Vegaprene 2 compositions for application of the hose, cable coating type.

However, it is obvious that these examples are given solely as illustrations of the subject matter of the invention, of which they do not in any way constitute a limitation.

### EXAMPLES

Various formulations were prepared according to the following method: the ingredients necessary for the preparation of the crosslinked composition are introduced into an internal mixer with appropriate shearing. While continuing to shear, the internal temperature of the mixers is brought to a value of 170° C. and, when this temperature is reached, the blends are maintained at this temperature for approximately 5 minutes. The masses thus obtained are cooled at the outlet of the mixers and are subjected to granulation.

The following are determined:
the Shore A hardness, according to the method described in standard NF T 46-052,
the tensile strength (TS) and the elongation at break (EB), according to the method described in standard ISO 37, of each of the compositions thus prepared, and also:
the compression set (CS) on completion of a compression of 25% applied at 100° C. for 22 hours, according to the method described in standard ISO 815, and
the elongation set (ES) on completion of an elongation of 20% applied for 70 hours, according to the method described in standard ISO 2285.

The compositions studies, expressed in parts, and the results obtained are summarized in the following tables.

It should noted that the compositions referenced (a) do not comprise triblock copolymers and thus constitute comparative examples.

SBM denotes a triblock (II) with a number-average molar mass of 60 000 comprising 50% by weight of PMMA.

TABLE 1
Compositions based on NR/BR

| | Reference | | | | |
|---|---|---|---|---|---|
| | A | B | C | D | E |
| NR | 80 | 80 | 80 | 80 | 80 |
| BR | 20 | 20 | 20 | 20 | 20 |
| SBM | | 5 | 10 | 20 | 30 |
| ZnO | 20 | 20 | 20 | 20 | 20 |
| Stearic acid | 2 | 2 | 2 | 2 | 2 |
| Black | 20 | 20 | 20 | 20 | 20 |
| Plasticizer | 4 | 4 | 4 | 4 | 4 |
| Protective | 4.5 | 4.5 | 4.5 | 4.5 | 4.5 |
| agents | | | | | |
| Accelerators | 1.5 | 1.5 | 1.5 | 1.5 | 1.5 |
| Sulfur | 1.5 | 1.5 | 1.5 | 1.5 | 1.5 |
| DC | 7.1 | 9.26 | 8.83 | 7.73 | 5.69 |
| Hardness | 44 | 47 | 49 | 53 | 55 |
| Tensile | 18.3 | 18.4 | 20.5 | 22.5 | 21.4 |
| strength | | | | | |
| (MPa) | | | | | |
| Standard | 1.1 | 0.9 | 1.2 | 0.9 | 1.1 |
| deviation | | | | | |
| (MPa) | | | | | |
| M50% (MPa) | 0.73 | 0.89 | 0.87 | 1.07 | 1.04 |
| M100% (MPa) | 1.12 | 1.39 | 1.37 | 1.69 | 1.57 |
| M200% (MPa) | 2.09 | 2.72 | 2.78 | 3.44 | 3 |
| M300% (MPa) | 3.76 | 5.01 | 5.15 | 6.26 | 5.27 |
| Delft tear | 14.3 | 16.6 | 37.0 | 38.7 | 48.0 |
| (kN/m) | | | | | |
| Standard | 2.1 | 0.8 | 2.9 | 2.6 | 8.1 |
| deviation | | | | | |
| (MPa) | | | | | |
| CS, 22 h at | 42 | 42 | 51 | 56 | 54 |
| 100° C., | | | | | |
| ss 25% | | | | | |
| Zwick | 74 | 74 | 72 | 66 | 57 |
| rebound (%) | | | | | |

TABLE 2
Formulations based on NR

Reference

| | A | B | C | D |
|---|---|---|---|---|
| NR | 100 | 100 | 100 | 100 |
| SMB | | 5 | 7 | 10 |
| ZnO | 20 | 20 | 20 | 20 |
| Stearic acid | 2 | 2 | 2 | 2 |
| Protective agents | 4.5 | 4.5 | 4.5 | 4.5 |
| Accelerators | 1.5 | 1.5 | 1.5 | 1.5 |
| Sulfur | 1.5 | 1.5 | 1.5 | 1.5 |
| DC | 6.76 | 6.19 | 6.64 | 5.52 |
| Hardness | 39 | 38 | 41 | 46 |
| Tensile strength | 15.6 | 16.4 | 18.4 | 19.4 |
| (MPa) | | | | |
| Standard deviation | 1.5 | 1.3 | 0.7 | 0.7 |
| (MPa) | | | | |
| Elongation at | 650 | 620 | 660 | 670 |
| break (%) | | | | |
| Standard deviation | 20 | 25 | 10 | 10 |
| (%) | | | | |
| M50% (MPa) | 0.52 | 0.62 | 0.62 | 0.77 |
| M100% (MPa) | 0.77 | 0.87 | 0.88 | 1.04 |
| M200% (MPa) | 1.22 | 1.32 | 1.37 | 1.52 |
| M300% (MPa) | 1.77 | 1.94 | 2.06 | 2.22 |
| Delft tear (kN/m) | 8.5 | 9.0 | 12.1 | 15.7 |
| Standard deviation | 1.1 | 0.3 | 1.0 | 1.1 |
| (MPa) | | | | |
| CS, 22 h at 100° C., | 40 | 38 | 42 | 43 |
| ss 25% | | | | |
| Zwick rebound (%) | 82 | 78 | 79 | 77 |

On reading tables 1 and 2, it is found that there is a significant improvement in the Delft tear, which is indicative of better fatigue behavior (under repeated mechanical stresses), this being achieved without the other important characteristics for the application being modified (CS, rebound). This is an improvement made to the crosslinked formulations, whether or not they have a thermoplastic conversion mode.

TABLE 3
Compositions based on EPDM

Reference

| | A | B | C | D |
|---|---|---|---|---|
| EPDM | 175 | 175 | 175 | 175 |
| SMB | | 5 | 10 | 15 |
| ZnO | 5 | 5 | 5 | 5 |
| Stearic acid | 1.5 | 1.5 | 1.5 | 1.5 |
| Black | 78 | 78 | 78 | 78 |
| Plasticizer | 12 | 12 | 12 | 12 |
| Accelerators | 2.5 | 2.5 | 2.5 | 2.5 |
| Sulfur | 0.66 | 0.66 | 0.66 | 0.66 |
| Hardness | 48 | 45 | 44 | 43 |
| Tensile strength | 18.7 | 20 | 18.9 | 18.7 |
| (MPa) | | | | |
| Standard deviation | 0.4 | 0.6 | 0.7 | 0.3 |
| (MPa) | | | | |
| Elongation at | 560 | 610 | 630 | 660 |
| break (%) | | | | |
| Standard deviation | 10 | 15 | 15 | 10 |
| (%) | | | | |
| M50% (MPa) | 0.74 | 0.65 | 0.6 | 0.6 |
| M100% (MPa) | 1.3 | 1.1 | 1 | 0.9 |
| M200% (MPa) | 3.6 | 3 | 2.5 | 2.7 |
| M300% (MPa) | 6.6 | 5.7 | 5.1 | 5 |
| Delft tear (kN/m) | 18.8 | 20 | 21.3 | 22.5 |
| Standard deviation | 0.6 | 0.4 | 0.6 | 0.6 |
| (MPa) | | | | |
| CS, 22 h at 125° C., | 40 | 40 | 39 | 40 |
| ss 25% | | | | |
| Zwick rebound (%) | 63 | 62 | 61 | 60 |

TABLE 4
Formulations of Vegaprene type

| Reference | A | B |
|---|---|---|
| EPDM | 100 | 100 |
| PP | 63 | 63 |
| Black | 30 | 30 |
| Plasticizer | 70 | 70 |
| ZnO | 5 | 5 |
| Stearic acid | 1 | 1 |
| Peroxides | 3.5 | 3.5 |
| Protective agents | 1 | 1 |
| Processing aids | 1.5 | 1.5 |
| SBM | | 10 |
| Hardness | 77 | 71 |
| Tensile strength | 5 | 5 |
| (MPa) | | |
| Standard deviation | 0.15 | 0.15 |
| (MPa) | | |
| Elongation at break | 240 | 310 |
| (%) | | |
| Standard deviation | 15 | 25 |
| (%) | | |
| M 50% (MPa) | 3.21 | 2.48 |
| M 100% (MPa) | 3.93 | 3.13 |

Tables 3 and 4 show that there is an improvement in the elongation and in the Delft tear, which is important for the installation and the strength of the component.

TABLE 5
Formulation of Vegaprene 2 type

| Reference | A | B |
|---|---|---|
| EPDM | 100 | 100 |
| PP | 50 | 50 |
| Plasticizer | 30 | 30 |
| Black | 30 | 30 |
| ZnO | 4 | 4 |
| Peroxides | 4 | 4 |
| Processing aids | 6 | 6 |
| SBM | | 15 |
| Hardness | 63 | 64 |
| Tensile strength | 5.2 | 4.9 |
| (MPa) | | |
| Standard deviation | 0.1 | 0.1 |
| (MPa) | | |
| Elongation at break | 330 | 300 |
| (%) | | |
| Standard deviation | 10 | 10 |
| (%) | | |
| M 50% (MPa) | 2.3 | 2.4 |
| M 100% (MPa) | 3.5 | 3.6 |
| M 300% (MPa) | 4.8 | 4.3 |
| Delft tear (kN/m) | 10.8 | 11.2 |
| CS (22 h at 125° C., | 67 | 57 |
| ss 25%) | | |

It is found, on reading this table, that the CS at high temperature is improved.

1. A crosslinked composition comprising:
from 20 to 100 parts by weight of at least one elastomer (I),
from 2 to 50 parts by weight of at least one triblock block copolymer (II), at least one block of which is composed predominantly of methacrylic monomers,
from 0 to 100 parts by weight of at least one thermoplastic polymer (III).

2. The composition as claimed in claim 1, wherein the triblock block copolymer (II) corresponds to the following general formula Y—B—Y′ in which: B is an elastomeric block thermodynamically incompatible with the Y and Y′ blocks, and Y and Y′ may or may not have the same chemical composition and at least one of Y and Y′ comprises predominantly of methacrylic monomers.

3. The composition as claimed in claim 2, wherein B is an elastomeric block co-crosslinkable with the elastomer (I) and selected from the group consisting of polydienes, partially or completely hydrogenated polydienes, polyolefin elastomers, long-chain polyacrylates, nitrile elastomers and acrylic copolymers with low Tg values comprising pendant vinyl functional groups.

4. The composition as claimed in claim 3, wherein B is a polydiene obtained by the polymerization of at least one monomer selected from the group consisting of butadiene, isoprene, 2,3-dimethyl-1,3-butadiene, 1,3-pentadiene and 2-phenyl-1,3-butadiene.

5. The composition as claimed in claim 2, wherein Y and Y′ are obtained by the polymerization of at least one monomer selected from the group consisting of styrene and its derivatives, short-chain alkyl methacrylates, methyl methacrylate, functional monomers, acrylic acid, methacrylic acid and glycidyl methacrylate.

6. The composition as claimed in claim 5, wherein Y is a block composed predominantly of styrene and in that Y′ is a block comprising at least 50% by weight of methyl methacrylate.

7. The composition as claimed in claim 6, in which the Y′ block comprises imide functional groups.

8. The composition as claimed in claim 1, wherein the elastomer (I) is a compound selected from the group consisting of natural rubbers, synthetic rubbers, EPRs, EPDMs, elastomers with metallocene polymerization which may or may not be modified, poly(octene/ethylene), long-chain polyacrylates of polyolefin elastomers, long-chain polyacrylates, poly(butyl acrylate), of poly(2-ethylhexyl acrylate), fluoroelastomers (FPMs), copolymers based on tetrafluoroethylene, and silicone elastomers.

9. The composition as claimed in claim 8, wherein the elastomer (I) is poly(octene/ethylene).

10. The composition as claimed in claim 9, wherein said composition can be converted like a thermoplastic.

11. The composition as claimed in claim 1, wherein the thermoplastic polymer is chosen from grafted polyolefins, grafted with acrylic acid, maleic anhydride or glycidyl methacrylate.

12. The composition as claimed in claim 1, comprising, before crosslinking, at least one crosslinking system which comprises one or more crosslinking agents and one or more crosslinking promoters.

13. The composition as claimed in claim 12, wherein the crosslinking system comprises, as crosslinking agent, one or more organic peroxides selected from the group consisting of dicumyl peroxide, 1,3-bis(t-butylisopropyl)benzene, 2,5-dimethyl-2,5-bis(t-butyl)hexane peroxide and 1,1-bis(t-butyl)-3,3,5-trimethylcyclohexane;
and, as crosslinking promoter(s), one or more compounds selected from the group consisting of zinc oxide, stearic acid, N,N′-(m-phenylene)dimaleimide, triallyl cyanurate, triisoallyl cyanurate, dimethacrylates, trimethacrylates, diacrylates and triacrylates.

14. The composition as claimed in claim 12, wherein the crosslinking system is based on sulfur and comprises, in addition to zinc oxide and/or stearic acid as crosslinking promoters, one or more sulfur-donating activators and optionally an antireversion agent.

15. The composition as claimed in claim 12, wherein the crosslinking system comprises, as crosslinking agent, a phenolic resin chosen from reactive alkylated methylphenol/formaldehyde and bromomethylphenol/formaldehyde resins and, as crosslinking promoter, a chloropolymer, optionally in combination with zinc oxide and/or stearic acid.

16. The composition as claimed in claim 13, wherein the crosslinking agent and the crosslinking promoter are present at a content of between 0.5 and 12 parts by weight per 100 parts of the blend.

17. The crosslinked composition as claimed in claim 1, further comprising a plasticizer and/or fillers of the light-colored fillers type or carbon blacks type and/or adjuvants.

18. A process for the preparation of the crosslinked composition claim 1, comprising the steps of blending of at least one elastomer and of at least one triblock block copolymer, optionally in the presence of a thermoplastic polymer, of a plasticizer, of fillers and/or of adjuvants, and Xe crosslinking this blend by an appropriate crosslinking system at a suitably chosen temperature.

19. The process as claimed in claim 18, wherein said crosslinking occurs at a temperature of between 150 and 320° C.

20. The process as claimed in claim 18, wherein the crosslinking is carried out for a time of between 1 and 15 minutes.

21-28. (canceled)

29. An article of manufacture comprising the composition of claim 1.

30. The article of manufacture of claim 29 comprising an insulation, leaktight seal, conduit, pipe, hose, manifold, nozzle, electric cable, tire, belt, or shoe sole.
